(19) United States
(12) Patent Application Publication
(10) Pub. No.: US 2022/0237950 A1
(43) Pub. Date: Jul. 28, 2022

(54) INTELLIGENT VISUAL HUMAN BEHAVIOR PREDICTION

(71) Applicant: eConnect, Inc., Las Vegas, NV (US)

(72) Inventors: Henry Valentino, III, Las Vegas, NV (US); Jack Coronel, Las Vegas, NV (US); Richard B. Lopez, San Rafael, CA (US); Malcolm Rutherford, Las Vegas, NV (US)

(21) Appl. No.: 17/718,261

(22) Filed: Apr. 11, 2022

Related U.S. Application Data
(63) Continuation of application No. PCT/US2020/055422, filed on Oct. 13, 2020.

(51) Int. Cl. G06V 40/20; G06V 40/16; G06V 20/52

(52) U.S. Cl. CPC G06V 40/23; G06V 20/52; G06V 40/172

(57) ABSTRACT

Technologies and implementations for facilitating pattern determination and determination of a subsequent activities (e.g., motion and/or behavior) of a person based, at least in part, on the determined pattern may be provided. In some other technologies and implementations, information about a recognized person may be verified and/or confirmed passively. In some other technologies and implementations, a person's motion and/or or habits may be utilized to facilitate recognition of the person.

### RELATED APPLICATION

This application claims priority to and the benefit of U.S. Provisional Patent Application No. 62/914,520, filed Oct. 13, 2019 titled “INTELLIGENT VISUAL HUMAN BEHAVIOR PREDICTION” which is incorporated herein by reference in its entirety for all purposes.

### BACKGROUND

Unless otherwise indicated herein, the approaches described in this section are not prior art to the claims in this application and are not admitted to be prior art by inclusion in this section.

Surveillance cameras have become prevalent in the world. Knowing that each person's face may be as personal as a person's fingerprint, DNA, retina, walking gate, etc., a person's face may be used to facilitate tracking of the person.

### SUMMARY

Described herein are various illustrative methods for intelligent human behavior tracking utilizing facial recognition. Example methods may include receiving a first digital image of a person's face, storing the first digital image, receiving a second digital image of a person's face, comparing the second digital image with the stored first digital image, determining if the first digital image substantially matches the second digital image, if it is determined that the first digital image substantially matches the second digital image, determining a first activity associated with the second digital image, and determining a subsequent plurality of activities associated with the second digital image, from the determined subsequent plurality of activities, generate a pattern associated with the subsequent plurality of activities, the generated pattern based, at least in part, on a dynamical system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates an example system for intelligent human behavior tracking utilizing facial recognition in accordance with various embodiments;

FIG. 2 illustrates an example system for intelligent human behavior tracking utilizing facial recognition within an establishment in accordance with various embodiments;

FIG. 3 illustrates an example system for intelligent human behavior tracking utilizing facial recognition including identification verification in accordance with various embodiments;

FIG. 4 illustrates an example system for intelligent human behavior tracking utilizing facial recognition passively in accordance with various embodiments;

FIG. 5 illustrates an example system for intelligent human behavior tracking utilizing facial recognition including determining a person's habits in accordance with various embodiments;

FIG. 6 illustrates an operational flow for determining a subsequent behavior of a person, arranged in accordance with at least some embodiments described herein;

FIG. 7 illustrates an example computer program product, arranged in accordance with at least some embodiments described herein; and

FIG. 8 is an illustration of a block diagram of an example computing device, all arranged in accordance with at least some embodiments described herein.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to intelligent human behavior tracking utilizing facial recognition.

Video surveillance has become common, including video surveillance for transactions involving money. Many transactions may be recorded by video. For example, it may be difficult to go shopping without at least being video recorded at a register where monetary transactions may be common. Even a simple transaction as buying a cup of coffee at a small coffee shop may involve being video recorded during the transaction. If a coffee shop may have video recordings, one could imagine establishments, where money is the product such as gambling establishments (e.g., casinos) and financial establishments (e.g., banks), having a multitude of transactions being video recorded on a daily basis. Video recordings may include images of persons involved with the transactions. Images of persons may help facilitate recognition of an individual person or a group of persons. As more and more images of a person exist in some digital form, a person may be recognized (e.g., facial recognition, body recognition, retinal recognition, three dimensional facial and/or body recognition, etc.), and the recognized person may be tracked.

In one non-limiting example scenario, a person may be in an establishment of some sort such as, but not limited to, a gambling establishment (e.g., casino). As the person is within boundary of an image capturing device (e.g., surveillance camera), the person's face may be captured by the surveillance camera. The facial image of the person may be processed and stored. As part of the processing, the facial image of the person may be processed to determine if a substantially matching facial image is available in a database. If a substantially matching facial image is available in a database, the processing may continue to flag the person and track the person's movements, transactions, etc., on the grounds of the establishment. For example, a person may have been an employee of a casino. The person may no longer be an employee of a casino. The person may no longer be an employee of the casino, and as such, the person may be excluded from certain areas of the casino, while permitted in other areas of the casino. In this example, the person may approach the casino and a surveillance camera may capture an image of the person. The image may be of the person's face. The image may be processed to determine if the person's face is recognized. The processing may determine that the person's face substantially matches the face of a former employee of the casino. Accordingly, the person may be flagged (i.e., restricted to various areas of the casino). As the person moves around on the casino grounds, the person's face may be continually recognized (e.g., facial image captured by various surveillance cameras located in various locations on the casino grounds). In this example, the person may move to a restricted area and the image of the person captured by the surveillance camera located within proximity of the restricted area. Because the person was recognized and flagged, personnel of the casino may be alerted to the fact that the former employee is in a restricted/prohibited area, and the casino personnel may take appropriate steps to remedy the situation.

There may be some proprietary reason for restricting former employees from being within certain areas. Accordingly, it may be desirable to prevent the former employee from entering a restricted area all together. In this example, an image of the person (e.g., former employee) may be captured as the person approaches the casino (e.g., surveillance camera at an entrance of the casino). The image of the person may be processed, and accordingly, the person may be recognized as a former employee and flagged. As the person moves around the casino grounds, the person may be continually tracked (i.e., continually recognizing and tracking the person with the use of the surveillance cameras). In addition to the facial recognition, the processing of images may include vector determinations of movement by what is captured by the surveillance cameras. For example, as a person walks, various movements of the limbs, torso, head, eyes, etc. may be captured by the cameras and processed. The processing may include analysis that may include directional analysis (e.g., vector analysis). The directional processing may help facilitate determination of direction of movement of the person. For example, as a person walks, the person's direction may be determined via the surveillance cameras, and accordingly, the casino personnel may be informed that the person may be headed towards a restricted area of the casino, thereby facilitating interception of the person prior to the person entering the restricted area.

In another example, the activities of a person may be processed to determine behavior. Continuing with the example of the person having restricted access to areas of the casino, the person may have a habit of playing certain types of games in a particular order (e.g., the person may play Blackjack, play slot machines, craps, and then cash out). The processing may include determining of the person's habits after some period of time. For example, the person's activities (i.e., the images of the person engaged in these activities) may be captured via the surveillance cameras for several days, weeks, months, etc. The captured images of the activities may be stored and processed to facilitate determination of the person's behavior/habits. In this example, once the image is captured of the person playing slot machines, casino personnel may be informed that the person will likely move to the craps. Accordingly, the casino personnel may be informed of the person's potential future activities, and the casino personnel may be prepared to anticipate the person's movements.

In another example, an establishment may have various restrictions for people who may or may not be able to enter the establishment such as, but not limited to, citizenship, age, residency, gender, etc. Continuing with the non-limiting example of a casino being the establishment, the casino may have a restriction related to age of a person who may enter or interact within the premises. In particular, a person who is under the age to 21 years may not be permitted to gamble, and accordingly, the person may not be permitted to enter the casino grounds. For example, a person, who may be under 21 years old, may desire to enter a casino. The person may present a form of identification (e.g., driver's license) at an entrance to a person or an automated kiosk. The driver's license may have been altered to have a photo of the person, while the date of birth may indicate that the person is over 21 years old (i.e., counterfeit identification/“fake id”). Thwarting the use of the fake id may be difficult based upon the quality of the fake id. However, thwarting the use of the fake id may be facilitated by utilization of electronic recognition.

Continuing with the example of a person under 21 years old attempting to enter a casino, the person may approach a kiosk and present their fake id (e.g., scan). However, in accordance with the various examples in the present disclosure, an image of the person may be captured by a surveillance camera proximate to the kiosk or on the kiosk. The captured image may be processed to identify and recognize the person. For example, the processing may include processing the face of the person to digitally store the characteristics of the person's face. Once processed, the person's face may be electronically searched in various databases to determine if there may be a substantial match with a face in one of the various databases. For example, the processing may search various social media databases such as, but not limited to, Facebook database (e.g., Facebook postings) available from Facebook, Inc. of Menlo Park, Calif., LinkedIn database (e.g., LinkedIn postings) available from LinkedIn Corporation of Mountain View, Calif., Google database (e.g., Google search) available from Google LLC of Mountain View, Calif., and the like. The processing may determine that a substantial match is available from one or more of the databases.

As an example, the person may have posted something on Facebook having a photo of themselves. The processing may determine that there is a substantial match of the facial image captured by the casino and the Facebook posting. Upon determining that there may be a substantial match of the person's face with the Facebook posting, processing may continue to search the Facebook database and/or various other databases to determine if the person's age may be located. As may be appreciated, the person may not necessarily post online their date of birth. However, various social networking may facilitate wishing a person Happy Birthday. The processing may determine that a person has a Birthday wish from a member of the social network, and accordingly, the person's date of birth may be interpolated (i.e., determined indirectly). Of course, there may be the occasion of locating information that includes the person's date of birth such as, but not limited to, a person's tax return, a person's public court proceedings (e.g., divorce proceedings, criminal record, etc.).

If the processing determines that there may be some discrepancy between the fake id and the person's age found in various databases, the person may be flagged. As part of being flagged, the person may be asked to produce a second form of identification prior to being permitted to enter the casino premises and/or engage in activities on the casino grounds. Alternatively, the person may be asked to proceed to a casino personnel for verification of the person's age and/or identification. As previously described, the person's movements may be tracked to ensure that the person does not necessarily veer from request for verification. In this example, the person's identification may be verified by utilizing information not necessarily from the presented form of identification.

Another example of intelligent human behavior tracking utilizing facial recognition may include facilitating prediction of a behavior of a person without receiving information from the person. A person may unconsciously have a routine that may ultimately tracked that may facilitate predicting various behaviors of the person. In a non-limiting example scenario, a person may decide to shop for shoes and proceeds to a department store to buy a pair of shoes. After purchasing a pair of shoes, the person may decide to buy a handbag that may complement the shoes. After making the purchases, the person may decide to go to a restaurant. In this simple example scenario, an image of the person's face may be captured by a surveillance camera as the person purchases the shoes. The captured image may be processed and stored in a database. A subsequent image of the person's face may be captured by a surveillance camera as the person purchases the handbag. The subsequent captured image may also be processed and stored. However, as part of the processing, the two captured images of the person's face may be determined to be substantially the same (i.e., facial recognition). The recognized face may also be stored in a database as facial recognition data. Further, a surveillance camera captures the image of the person's face at the restaurant. The captured image of the person's face at the restaurant may be processed to determine that there may be facial recognition data related to the person in a database some place.

The determination that there may be facial recognition data related to the person may include a recognition tag for the person. The person's face may be captured numerous times subsequently over a period of time (e.g., thousands-hundreds of thousands of times over a period of several months to several years). As the instances of the recognition tag for the person increases (e.g., linearly and/or exponentially), the enormous amount of data may be processed as a dynamical system. For example, a small sampling of the recognition tag may seem random, but however, a very large sampling of the recognition tag may produce various patterns of behavior (e.g., attractors related to dynamical systems). These patterns may facilitate prediction of the behavior of a person such as, but not limited to, the behavior of buying shoes, buying a handbag, and going to a restaurant as described above. As may be appreciated, the described examples facilitate tracking and prediction of a person's behavior without the person necessarily knowing that they are being tracked and without the need for the person to provide information (i.e., automated tracking and behavior prediction).

It is contemplated within the scope of the disclosure that determining a person's behavior may additionally help facilitate influence of the person's behavior. Some examples of method and apparatus for influencing a person's behavior may be illustrated in U.S. patent application Ser. No. 14/745,348, published as Application Publication No. US 2016/0371547 having the filing date of Jun. 19, 2015, which is expressly incorporated herein by reference.

As may be appreciated, the disclosed subject matter may have a wide variety of applications. Accordingly, it should be appreciated that the above non-limiting example scenario and the examples described may have been in the context of a casino, it is clearly contemplated that the disclose subject matter may include a wide variety to establishments, where knowing a person's movements may be determined such as, but not limited to, departments stores, banks, warehouses, office buildings, amusement parks, urban streets, and the like. Accordingly, the disclosed subject matter is not limited in these respects.

It should be appreciated by one of ordinary skilled in the relevant art that a wide variety of recognition methodologies may be employed including facial recognition methodologies having artificial intelligence/machine learning (AI) capabilities to facilitate at least some of the functionality described herein such as, but not limited to, AI capable processors available from Intel Corporation of Santa Clara, Calif. (e.g., Nervana™ type processors), available from Nvidia Corporation of Santa Clara, Calif. (e.g., Volta™ type processors), available from Apple Company of Cupertino, Calif. (e.g., A11 Bionic™ type processors), available from Huawei Technologies Company of Shenzen, Guangdong, China (e.g., Kirin™ type processors), available from Advanced Micro Devices, Inc. of Sunnyvale, Calif. (e.g., Radeon Instinct™ type processors), available from Samsung of Seoul, South Korea (e.g., Exynos™ type processors), and so forth. Accordingly, the disclosed subject matter is not limited in these respects. The utilization of artificial intelligence facial recognition may facilitate intelligent human behavior tracking as described herein.

Additionally, any of the above mentioned example processors may facilitate the various processing examples described in the present disclosure. Alternatively, various general purpose processors may facilitate the various processing examples described in the present disclosure such as, but not limited to, iCore series processors available from Intel Corporation of Santa Clara, Calif. (e.g., various generation Core i7, i8, i9, etc. processors). Accordingly, the disclosed subject matter is not limited in these respects. The utilization of facial recognition may facilitate intelligent human behavior tracking as described herein.

Further, as previously mentioned the human recognition may have been described with respect to facial recognition, but it is contemplated within the scope of the disclosed subject matter that the recognition may include various types of recognition such as, but not limited to, a person's gate (i.e., walking/motion recognition), retinal recognition, three dimensional facial and/or body recognition, iris recognition, etc. Accordingly, the disclosed subject matter is not limited in these respects.

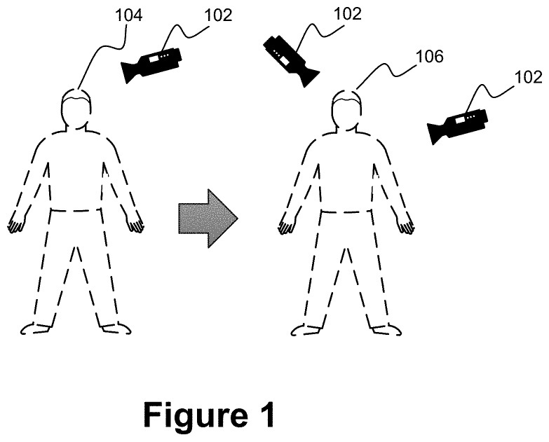

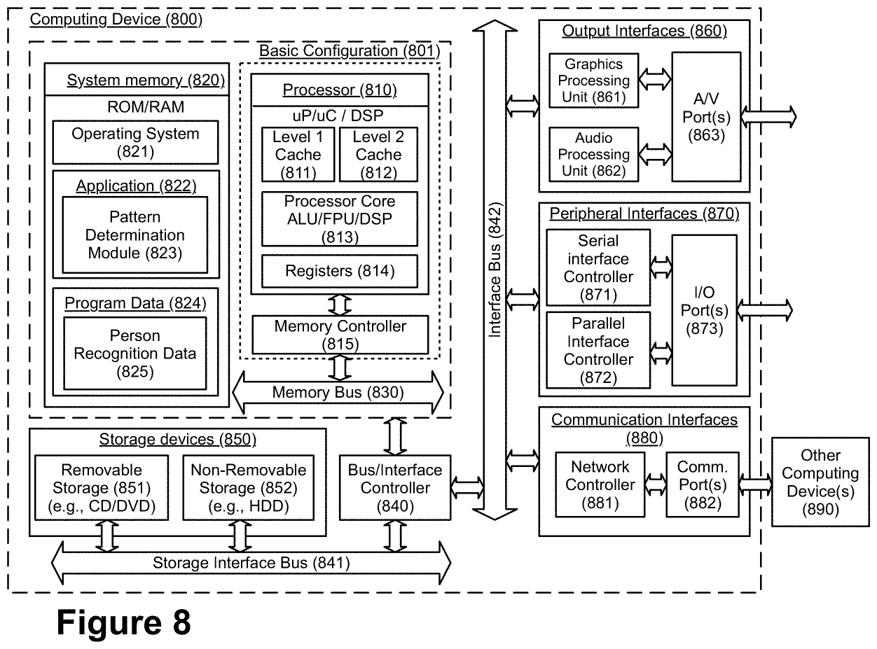

Turning now to FIG. 1. FIG. 1 illustrates an example system for intelligent human behavior tracking utilizing facial recognition in accordance with various embodiments. In FIG. 1, a system may be a video surveillance system 100 having one or more image capturing devices such as, but not limited to, one or more video cameras 102. The video cameras 102 may capture an image of a first person 104. Subsequently, the video cameras 102 may capture an image of a second person 106. The captured images of the first person 104 and the second person 106 may be electronically transmitted to a pattern determination module (PDM) 823 show in FIG. 8. As previously described with respect to the non-limiting examples above, the digital image of the first person and the digital image of the second person may be compared to determine if the first person and the second person is substantially the same person (i.e., same person). If it is determined that the captured images are of the same person, via video cameras 102, an activity associated with digital image of the first person 104 may be determined (i.e., what the person was doing during the video surveillance when the person was first detected). Additionally, via the video cameras 102, an activity associated with digital image of the second person 106 may be determined (i.e., what the person was doing during the video surveillance subsequent to the detection and recognition). From at least the determined activities, a pattern of behavior may be determined, and based, at least in part, on the determined pattern, a number of subsequent activities may be determined for the person, in accordance with various embodiments.

In one example, the recognition of the person may be determined by utilizing various facial recognition. In another example, the recognition of the person may be determined utilizing various motion of the person. That is, a person's movements such as, but not limited to, the movement of their limbs (e.g., during walking), movement of their torso (e.g., manner of standing or bending), movement of their head (e.g., shaking affirmative and/or negative), eye movements (e.g., rolling, blinking, twitching, etc.), and/or so forth. Methodologies employing artificial intelligence/machine learning (AI) capabilities may be utilized to facilitate the recognition process. Additionally, methodologies utilizing directional processing (e.g., vector analysis) may be utilized in combination with AI to develop a motion predictability. For example, if a person configured their body in a certain manner, the subsequent motion may be determined. For example, if a person turned their head in a certain direction, torso off centers in a certain direction, arms start to move in a certain direction, eyes look toward a certain direction, etc. may result in the person moving in a certain direction in a certain manner (i.e., walk, run, jump, etc.) As a result, a person's subsequent movements may be determined (i.e., predicted).

In another example, the recognition may involve utilizing dynamical systems. That is, if a person is recognized in a variety of settings, their movements, behaviors, activities, etc. may be recorded for a period of time. As more and more data is gathered, a pattern may develop. For example, limited or short periods of activity may seem random. However, a person's frequency of behavior over a long period of time may become predictable. Some examples of predictability may be found in randomness approaches (e.g., methodologies related to determining various information from seemingly random type systems such as, but not limited to, chaos theory related methodologies, Markov chain Monte Carlo methodologies, Monte Carlo methodologies, game theory, etc.). As a result, a person's behavior may be predicted and/or influenced, in accordance with various embodiments disclosed herein.

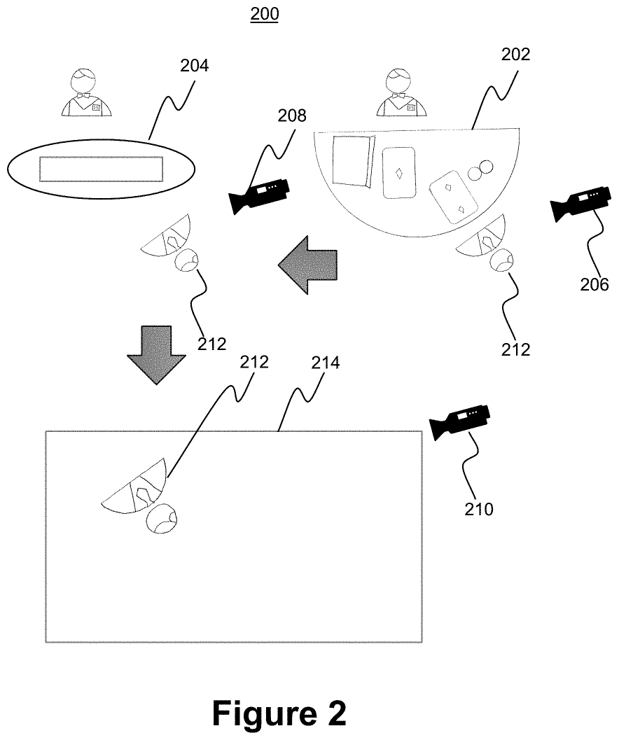

FIG. 2 illustrates an example system for intelligent human behavior tracking utilizing facial recognition within an establishment, in accordance with various embodiments. In FIG. 2, an establishment such as, but not limited to, a casino 200 may include various gaming areas such as, but not limited to, a blackjack table 202 and a dice gaming table 204. Additionally, the casino 200 may include a number of video surveillance cameras 206, 208, and 210. In FIG. 2, a person 212 may be allowed to play at the blackjack table 202 and the dice gaming table 204. However, the person 212 may be not permitted in an area of the casino 200 such as, but not limited to, slot machine area 214. As previously described, the person 212 may have first play at the blackjack table 202, where the surveillance camera 206 may capture images of the person 212. At this point, the person 212 may be recognized or may be recognized at a later time as described herein. After playing blackjack, the person 212 may move on to play at the dice game table 204, where the surveillance camera 208 may capture images of the person 212. Having captured at least two images of the person 212, the person 212 may be recognized as being the same person. After playing the dice game, the person 212 may move on to the slot machine area 214, where the surveillance camera 210 may capture images of the person 212.

Perhaps, in a non-limiting scenario, initially, the person 212 may not have been prohibited from playing slot machines (i.e., allowed to be in the slot machine area 214. Subsequently, for whatever reason, the person 214 may be prohibited from playing the slot machines. Accordingly, after a period of time, habits of the person 212 may be recorded, where the movements of the person 212 within the casino 200 may be determined prior to the person 212 actually moving. For example, in FIG. 2, the person 212 may be at the blackjack table 202, where the surveillance camera 206 may capture images of the person 212. Subsequently, the person 212 may move to the dice game table 204, where the surveillance camera 208 may capture images of the person 212. At this point, the person 212 captured by surveillance camera 206 may be the same person 212 captured by the surveillance camera 208 (i.e., recognized as the same person). Once the person 212 has been recognized, the activities associated with the images may be determined. In FIG. 2, the blackjack table may be associated with first surveillance camera 206 (e.g., person 212 playing blackjack), and the dice game table may be associated with the second surveillance camera 208 (e.g., person 212 playing a dice game). It may be determined that the next place the person 212 may move on to may be the slot machines (i.e., the prohibited area 214). As a result, the person may be captured in the prohibited area 214 by the surveillance camera 210. This may facilitate prevention of the person 212 entering the prohibited area 214 and/or it may facilitate detection of the person 212 in the prohibited area 214.

In the example illustrated in FIG. 2 may have been described with respect to a casino, but it should be appreciated that it is contemplated within the scope of the claimed subject matter that a wide variety of establishments may be applicable such as, but not limited to, grocery stores, department stores, cafes, restaurants, etc. Accordingly, the claimed subject matter is not limited in this respect.

It should be appreciated that even though the above examples may be described with respect to recognizing a person, it is contemplated within the scope of the claimed subject matter that recognizing a person may be facilitated by recorded activities such as, but not limited to, habits, bodily movements, manner of motion, etc. Accordingly, the claimed subject matter is not limited in this respect.

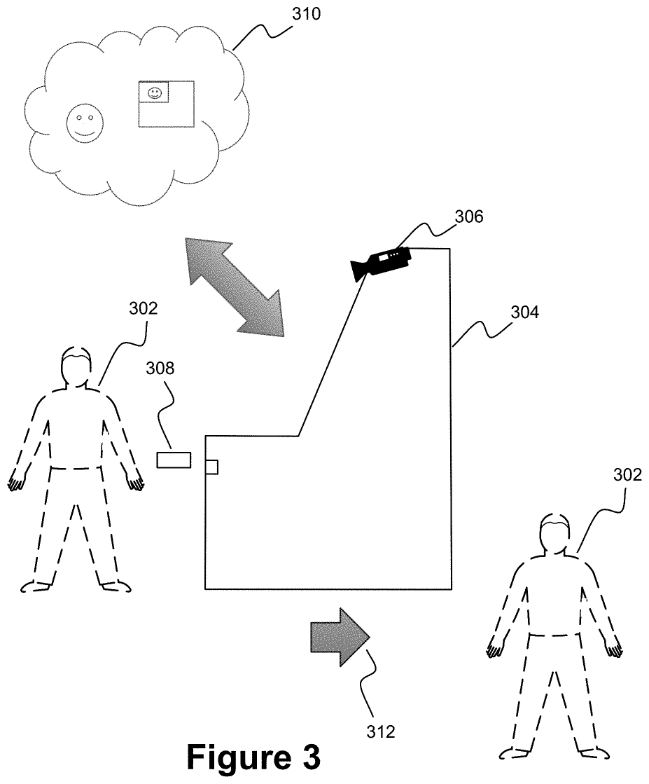

FIG. 3 illustrates an example system for intelligent human behavior tracking utilizing facial recognition including identification verification, in accordance with various embodiments. In FIG. 3, a person 302 may be shown walking up to a kiosk 304, where a surveillance camera 306 may capture an image of the person 302. The kiosk may be configured to receive the person's identification card 308 and verify that the person is the same person (e.g., confirm the identification of the person 302). Having the two images of the person (e.g., the captured image and the identification card 308), recognition of the person 302 (i.e., it is the same person) may be facilitated. However, to confirm various information on the identification card 308 (e.g., date of birth), the kiosk 304 may search various databases such as, but not limited to, social networking databases 310 to confirm the date of birth of the person 302, as previously described. Once the information has been confirmed the person 302 may proceed to enter the establishment. Here again, recognition may be based on a variety of recognition approaches such as, but not limited to, facial recognition, behavioral recognition, motion recognition, etc. Accordingly, the claimed subject matter is not limited in this respect.

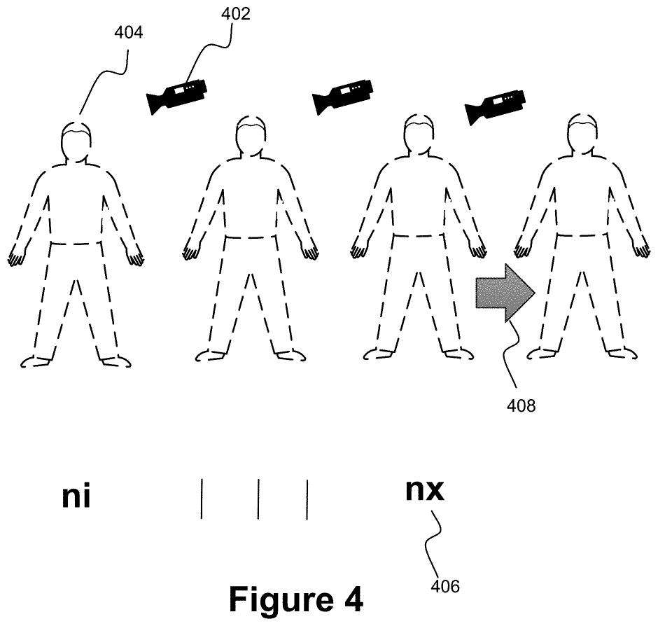

FIG. 4 illustrates an example system for intelligent human behavior tracking utilizing facial recognition passively, in accordance with various embodiments. In FIG. 4, an image capture device 402 may capture an image of a person 404. As shown, the person 404 may be recognized, in accordance with various approaches described herein. Once the person 404 is recognized, a number activities 406 associated with each time an image of the person is captured may be recorded. After a number of times (n₁-nₓ), a pattern may emerge, and based, at least in part, on the pattern, a subsequent movement and/or behavior 408 may be determined, in accordance with various embodiments disclosed herein.

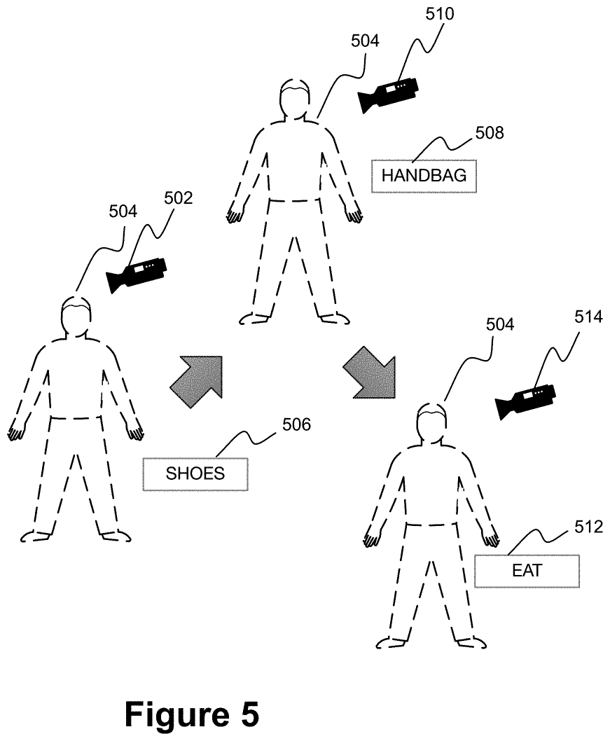

FIG. 5 illustrates an example system for intelligent human behavior tracking utilizing facial recognition including determining a person's habits, in accordance with various embodiments. In FIG. 5, an image capture device 502 may capture an image of a person 504. In this example, the person 504 may purchase shoes 506 (e.g., activity associated with a first image capture 502). After purchasing shoes 506, the person 504 may purchase a handbag 508 (e.g., activity associated with a second image capture 510). After purchasing handbag 508, the person 504 may decide to eat at a particular establishment 512, where an image capture device 514 may capture an image of the person eating. Over a period of time, the person 504 may substantially repeat this process/habit. Because a pattern may form after numerous recordings/tracking, the behavior of the person 504 may be determined (e.g., buy shoes 506, buy handbag 508, and eat meal at establishment 512). Once this behavior is determined, the person 504 may be susceptible to influences to promote this determined behavior. For example, when the image capture device 502 captures the person 504 buying shoes 506, the person may be provided a incentive to buy a handbag (e.g., a coupon) and/or a suggestion of a handbag that may complement the shoes may be suggested to the person by various means such as, but not limited to, a notification on their mobile device, a coupon at check out, an advertisement in their social networking application, an advertisement in their browser, news feed, etc. As a result, determining a person's pattern may help facilitate reinforcing and/or influencing a person's behavior movements.

Here again, it should be appreciated that the person 502 may be recognized by their activity associated with the images captured. That is, the person 504 may be recognized by the pattern of buying shoes 506, subsequently buying a handbag 508, and eating 512 after buying shoes 506 and handbag 508. The number of image captures (e.g., activities) may be small to large number to facilitate determination of a pattern. As a result, a person's future behavior and/or movements may be determined, in accordance with various embodiments.

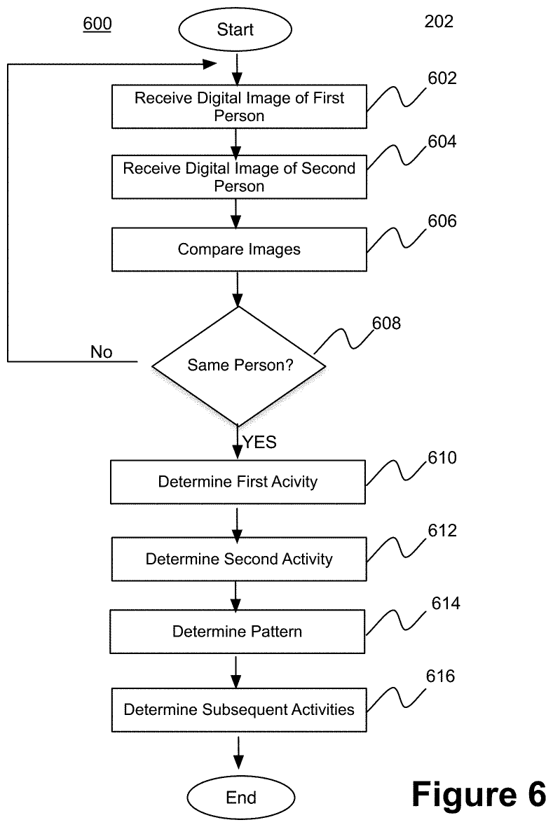

FIG. 6 illustrates an operational flow for determining a subsequent behavior of a person, arranged in accordance with at least some embodiments described herein. In some portions of the description, illustrative implementations of the method are described with reference to elements of FIGS. 1-5 and 7-8. However, the described embodiments are not limited to these depictions. More specifically, some elements depicted in FIG. 8 may be omitted from some implementations of the methods detailed herein. Furthermore, other elements not depicted in FIG. 8 may be used to implement example methods detailed herein.

Additionally, FIG. 6 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

In some examples, operational flow 600 may be employed as part of a pattern determination module (PDM) 823 (shown in FIG. 8). Beginning at block 602 (“Receive Digital Image of First Person”), the pattern determination module (PDM) 823 may receive a digital image of a first person from a video capture device.

Continuing from block 602 to 604 (“Receive a Digital Image of a Second Person”), the PDM 823 may receive a digital image of a second person from another video capture device.

Continuing from block 604 to 606 (“Compare Images”), the PDM 823 may compare the digital image of the first person and the digital image of the second person.

Continuing from block 606 to decision diamond 608 (“Same Person?”), the PDM 823 may determine if the first person and the second person is substantially the same person.

If it is determined that the first person and the second person is substantially the same person, the operation flow continues from the decision diamond 608 to block 610 (“Determine First Activity”), the PDM 823 may determine a first activity associated with the received digital image of the first person.

Continuing from block 610 to 612 (“Determine Second Activity”), the PDM 823 may determine a second activity associated with the received digital image of the second person.

Continuing from block 612 to 614 (“Determine Pattern”), the PDM 823 may determine a pattern based at least in part, on the determined second activity.

Continuing from block 614 to 616 (“Determine Subsequent Activities”), the PDM 823 may determine a subsequent number of activities (e.g., motion and/or behavior) of the person base, at least in part, on the determined pattern.

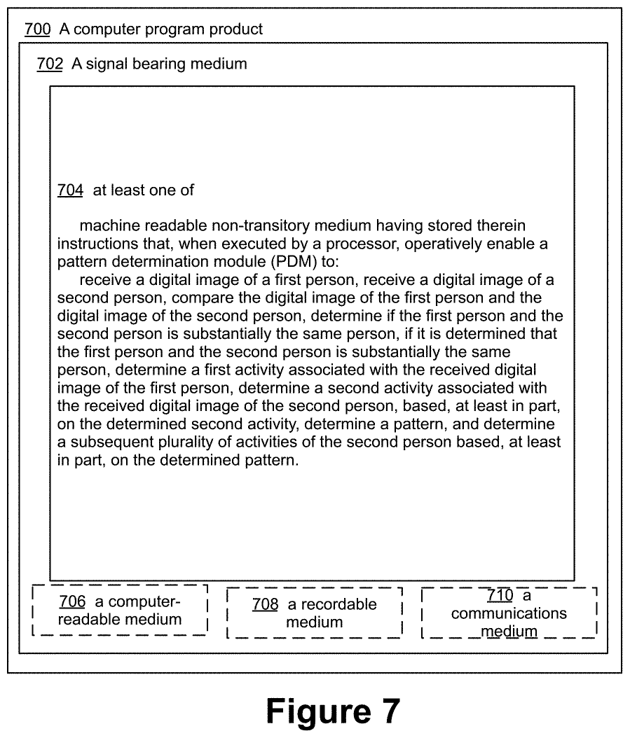

In general, the operational flow described with respect to FIG. 6 and elsewhere herein may be implemented as a computer program product, executable on any suitable computing system, or the like. For example, a computer program product for determining advantages patterns may be provided. Example computer program products are described with respect to FIG. 7 and elsewhere herein.

In general, operations and processing herein may be implemented as a computer program product, executable on any suitable computing system, or the like. For example, a computer program product for facilitating intelligent pattern determination may be provided. Example computer program products are described with respect to FIG. 7 and elsewhere herein.

FIG. 7 illustrates an example computer program product 700, arranged in accordance with at least some embodiments described herein. Computer program product 700 may include machine readable non-transitory medium having stored therein instructions that, when executed, cause the machine to facilitate determination of a pattern, and based at least in part, on the determined pattern, facilitate determination of a number of subsequent activities of a person according to the processes and methods discussed herein. Computer program product 700 may include a signal bearing medium 702. Signal bearing medium 702 may include one or more machine-readable instructions 704, which, when executed by one or more processors, may operatively enable a computing device to provide the functionality described herein. In various examples, some or all of the machine-readable instructions may be used by the devices discussed herein.

In some examples, the machine readable instructions 704 may include receive a digital image of a first person. In some examples, the machine readable instructions 704 may include receive a digital image of a second person. In some examples, the machine readable instructions 704 may include compare the digital image of the first person and the digital image of the second person. In some examples, the machine readable instructions 704 may include determine if the first person and the second person is substantially the same person. In some examples, the machine readable instructions 704 may include if it is determined that the first person and the second person is substantially the same person, determine a first activity associated with the received digital image of the first person. In some examples, the machine readable instructions 704 may include determine a second activity associated with the received digital image of the second person. In some examples, the machine readable instructions 704 may include based, at least in part, on the determined second activity, determine a pattern. In some examples, the machine readable instructions 704 may include determine a subsequent plurality of activities of the second person based, at least in part, on the determined pattern.

In some implementations, signal bearing medium 702 may encompass a computer-readable medium 706, such as, but not limited to, a hard disk drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communication link, a wireless communication link, etc.). In some examples, the signal bearing medium 802 may encompass a machine readable non-transitory medium.

In general, the methods and processes described herein may be implemented in any suitable computing system. Example systems may be described with respect to FIG. 8 and elsewhere herein. In general, the system may be configured to facilitate determination of a pattern and determination of a subsequent activities (e.g., motion and/or behavior) of a person based, at least in part, on the determined pattern.

FIG. 8 is a block diagram illustrating an example computing device 800, such as might be embodied by a person skilled in the art, which is arranged in accordance with at least some embodiments of the present disclosure. In one example configuration 801, computing device 800 may include one or more processors 810 and system memory 820. A memory bus 830 may be used for communicating between the processor 810 and the system memory 820.

Depending on the desired configuration, processor 810 may be of any type including but not limited to a microprocessor (μP), a microcontroller (μC), a digital signal processor (DSP), or any combination thereof. Processor 810 may include one or more levels of caching, such as a level one cache 811 and a level two cache 812, a processor core 813, and registers 814. The processor core 813 may include an arithmetic logic unit (ALU), a floating point unit (FPU), a digital signal processing core (DSP Core), or any combination thereof. A memory controller 815 may also be used with the processor 810, or in some implementations the memory controller 815 may be an internal part of the processor 810.

Depending on the desired configuration, the system memory 820 may be of any type including but not limited to volatile memory (such as RAM), non-volatile memory (such as ROM, flash memory, etc.) or any combination thereof. System memory 820 may include an operating system 821, one or more applications 822, and program data 824. Application 822 may include pattern determination module (PDM) 823 that is arranged to perform the functions as described herein including the functional blocks and/or actions described. Program Data 824 may include person recognition data 825 for use with pattern recognition analysis algorithm 823. In some example embodiments, application 822 may be arranged to operate with program data 824 on an operating system 821 such that implementations of facilitating pattern determination and determination of a subsequent activities (e.g., motion and/or behavior) of a person based, at least in part, on the determined pattern may be provided as described herein. For example, apparatus described in the present disclosure may comprise all or a portion of computing device 800 and be capable of performing all or a portion of application 822 such that implementations of facilitating determination of a pattern and determination of a subsequent activities (e.g., motion and/or behavior) of a person based, at least in part, on the determined pattern may be provided as described herein. This described basic configuration is illustrated in FIG. 8 by those components within dashed line 801.

Computing device 800 may have additional features or functionality, and additional interfaces to facilitate communications between the basic configuration 801 and any required devices and interfaces. For example, a bus/interface controller 840 may be used to facilitate communications between the basic configuration 801 and one or more data storage devices 850 via a storage interface bus 841. The data storage devices 850 may be removable storage devices 851, non-removable storage devices 852, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable, and non-removable media implemented in any method or technology for storage of information, such as computer readable instructions, data structures, program modules, or other data.

System memory 820, removable storage 851 and non-removable storage 852 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of device 800.

Computing device 800 may also include an interface bus 842 for facilitating communication from various interface devices (e.g., output interfaces, peripheral interfaces, and communication interfaces) to the basic configuration 801 via the bus/interface controller 840. Example output interfaces 860 may include a graphics processing unit 861 and an audio processing unit 862, which may be configured to communicate to various external devices such as a display or speakers via one or more A/V ports 863. Example peripheral interfaces 860 may include a serial interface controller 871 or a parallel interface controller 872, which may be configured to communicate with external devices such as input devices (e.g., keyboard, mouse, pen, voice input device, touch input device, etc.) or other peripheral devices (e.g., printer, scanner, etc.) via one or more I/O ports 873. An example communication interface 880 includes a network controller 881, which may be arranged to facilitate communications with one or more other computing devices 890 over a network communication via one or more communication ports 882. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 800 may also be implemented as a personal computer including both laptop computer and non-laptop computer configurations. In addition, computing device 800 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

What is claimed:

1. A method comprising:
receiving a digital image of a first person;
receiving a digital image of a second person;
comparing the digital image of the first person and the digital image of the second person;
determining if the first person and the second person is substantially the same person;
if it is determined that the first person and the second person is substantially the same person, determining a first activity associated with the received digital image of the first person;
determining a second activity associated with the received digital image of the second person;
based, at least in part, on the determined second activity, determining a pattern; and
determining a subsequent plurality of activities of the second person based, at least in part, on the determined pattern.

2. The method of claim 1, wherein determining if the first person and the second person is substantially the same person comprises facial recognition.

3. The method of claim 1, wherein determining the second activity associated with the received digital image of the second person comprises capturing and processing movements of at least one of the first person's limbs, torso, head, or eyes.

4. The method of claim 1, wherein determining the pattern comprises determining the pattern based, at least in part, on dynamical systems.

5. The method of claim 1, wherein determining the subsequent plurality of activities of the second person based comprises directional processing.

6. The method of claim 1, wherein determining if the first person and the second person is substantially the same person comprises electronically searching a social media database.

7. The method of claim 6, wherein searching the social media database comprises determining information of the first person and the second person indirectly.

8. The method of claim 1, wherein determining the pattern comprises receiving a subsequent plurality of images of the second person.

9. A system comprising:
a processor;
a pattern determination module (PDM) communicatively coupled to the processor; and
a non-transitory machine readable medium communicatively coupled to the PDM having stored therein a plurality of instructions, which, when executed by the processor, operatively enable a computing device to receive a digital image of a first person, receive a digital image of a second person, compare the digital image of the first person and the digital image of the second person, determine if the first person and the second person is substantially the same person, if it is determined that the first person and the second person is substantially the same person, determine a first activity associated with the received digital image of the first person, determine a second activity associated with the received digital image of the second person, based, at least in part, on the determined second activity, determine a pattern, and determine a subsequent plurality of activities of the second person based, at least in part, on the determined pattern.

10. The system of claim 9, wherein when executed by the processor, further operatively enable the computing device to utilize facial recognition.

11. The system of claim 9, wherein when executed by the processor, further operatively enable the computing device to capture and process movements of at least one of the second person's limbs, torso, head, or eyes.

12. The system of claim 9, wherein when executed by the processor, further operatively enable the computing device to determine the pattern based, at least in part, on dynamical systems.

13. The system of claim 9, wherein when executed by the processor, further operatively enable the computing device to determine directional processing.

14. The system of claim 9, wherein when executed by the processor, further operatively enable the computing device to electronically search a social media database.

15. The system of claim 14, wherein when executed by the processor, further operatively enable the computing device to determine information of the first person and the second person indirectly.

16. The system of claim 9, wherein when executed by the processor, further operatively enable the computing device to receive a subsequent plurality of images of the second person.
